(19) United States
(12) Patent Application Publication
(10) Pub. No.: US 2010/0141859 A1
(43) Pub. Date: Jun. 10, 2010

(54) DISPLAY DEVICE INCLUDING UV-ABSORBING FILTER

(76) Inventors: Hong-Jo Park, Suwon-si (KR); Hyeok-Jin Lee, Seongnam-si (KR); Oh-Jeong Kwon, Suwon-si (KR); Sung-Jae Yun, Yongin-si (KR); Hee-Seop Kim, Hwaseong-si (KR)

Correspondence Address: Innovation Counsel LLP, 21771 Stevens Creek Blvd, Ste. 200A, Cupertino, CA, 95014, US

(21) Appl. No.: 12/631,710

(22) Filed: Dec. 4, 2009

(30) Foreign Application Priority Data
Dec. 4, 2008 (KR) 10-2008-0122712

(51) Int. Cl. G02F 1/1368; G02F 1/1335; G02F 1/1343

(52) U.S. Cl. 349/39; 349/104; 349/48; 349/46; 349/183

(57) ABSTRACT

The present invention provides a display device including: a first substrate; a second substrate arranged opposite to the first substrate; a liquid crystal layer disposed between the first substrate and the second substrate; and a UV-absorbing filter formed on each of the first substrate and the second substrate, wherein the liquid crystal layer undergoes a phase transition from an isotropic phase in the absence of a voltage to an anisotropic phase when an electric field is applied to the liquid crystal layer.

### CROSS-REFERENCE TO RELATED APPLICATION

This application claims priority to and the benefit of Korean Patent Application No. 10-2008-0122712 filed in the Korean Intellectual Property Office on Dec. 4, 2008, the entire content of which is incorporated herein by reference.

### BACKGROUND OF THE INVENTION

(a) Field of the Invention

The present invention relates to a display device. More particularly, the present invention relates to a display device using a blue phase liquid crystal.

(b) Description of the Related Art

There are various types of display devices. Among them, a liquid crystal display (LCD) has attracted much attention as a promising display device of which performance is improved and the size and weight are reduced as semiconductor techniques rapidly advance.

The light transmittance of the liquid crystal display is determined by the alignment state of a liquid crystal layer. Since the light transmittance is controlled by physical movement of the liquid crystal layer, the liquid crystal display has a problem of slow response speed.

Recently, a blue phase liquid crystal (LC) having a very fast response time of about 3 μs has been developed. Since the blue phase LC has a narrow operating temperature range, a monomer is added and polymerized to stabilize the crystal structure of the blue phase LC.

As can be seen from the name, the blue phase LC causes a blue light reflection when the device is maintained within a narrow operating temperature range. At an early stage, such a phenomenon was not given particular attention; however, this phenomenon has become known as selective Bragg reflection since its structure has been gradually revealed. In general, reflected light with a wavelength, λ, corresponding to a given pitch is observed on a chiral nematic liquid crystal. However, in the blue phase LC, reflected light having a different wavelength from the actual pitch is observed, and the reason is that the blue phase has a regular cubic lattice structure.

In the case where a display is created using a blue phase LC, such a reflection phenomenon increases the black luminance level and allows an image to display a color even in a black state. In the reflection phenomenon on an actual panel, circular polarization reacted by the light selectivity induced by chirality for external light is reflected, and unreacted circular polarization is transmitted as it is. The result is that light leakage is observed on the front side, even though polarizers are arranged such that polarization axes form an angle of 90 degrees relative to one another, on the upper and lower substrates of a liquid crystal panel (cross-polarization). The light leakage phenomenon is caused by the backlight and also by external light reflected on the front side.

The results of light reflection occurring in an actual liquid crystal cell measured by an ultraviolet-visible (UV-Vis) spectrometer are shown in FIG. 11.

In the case where a liquid crystal pitch of 200 to 300 nm is used in the existing blue phase LC cell, there is a drawback in that the light ranging from the blue wavelength band to the ultraviolet wavelength band is easily reflected due to the reflection region of the above-described blue phase liquid crystal display, thus reducing the contrast ratio. When the pitch of the liquid crystal is reduced to overcome the above drawback, there is a problem in that the driving voltage of the liquid crystal display should be relatively increased.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a display device having advantages of reducing black luminance by reducing reflection of a blue phase liquid crystal and preventing a bluish cast.

An exemplary embodiment of the present invention provides a display device including: a first substrate; a second substrate arranged opposite to the first substrate; a liquid crystal layer disposed between the first substrate and the second substrate; a first thin film transistor and a second thin film transistor formed on the first substrate; a first electrode and a second electrode formed on the first substrate; and a UV-absorbing filter formed on at least one outer surface of the first substrate and the second substrate, wherein the liquid crystal layer undergoes a phase transition from an isotropic phase in the absence of voltage to an anisotropic phase when an electric field is applied to the liquid crystal layer.

The liquid crystal layer may further include a cured polymer.

The UV-absorbing filter may be formed integrally with or separately from a polarizer.

A color filter layer may be formed on the thin film transistor.

An inorganic capping layer may be formed on the color filter layer.

According to the present invention, it is possible to reduce black luminance, prevent a bluish cast, and reduce the driving voltage of a liquid crystal display by reducing Bragg reflection of light in the ultraviolet region from about 380 nm to about 420 nm incident to a cubic lattice structure of a blue phase liquid crystal in a blue phase liquid crystal display at an upper side or a lower side of the liquid crystal.

### BRIEF DESCRIPTION OF THE DRAWINGS

FIG. 1 is a layout view of a display device in accordance with a first exemplary embodiment of the present invention.

FIG. 2 is a cross-sectional view taken along line II-II of FIG. 1.

FIGS. 3A and 3B is a diagram showing a process of stabilizing a blue phase liquid crystal used in the display device of FIG. 1.

FIG. 4 is a diagram showing characteristics of the blue phase liquid crystal used in the display device of FIG. 1, which are changed according to whether an electric field is applied thereto.

FIG. 5 is a diagram showing a regular cubic lattice structure of blue phase in the blue phase liquid crystal of FIG. 3.

FIG. 6 is a cross-sectional view showing the lattice structure of the blue phase of FIG. 5.

FIG. 7 is a spectrum diagram showing the intensity of a light emitting diode/cold cathode fluorescent lamp used as a backlight, at various wavelengths.

FIG. 8 is a spectrum diagram of light passing through a blue phase liquid crystal display in a black state, when the backlight used is a light emitting diode/cold cathode fluorescent lamp.

FIG. 9 is a diagram showing the relationship between a pitch of the liquid crystal and a driving voltage in a blue phase liquid crystal display.

FIG. 10 is a diagram showing an ultraviolet/visible spectrum with respect to a transmission/reflection phenomenon in a blue phase liquid crystal cell.

FIG. 11A is a diagram showing the reflection of external light and backlight in a conventional blue phase liquid crystal display.

FIG. 11B is a cross-sectional view of a blue phase liquid crystal display in accordance with the exemplary embodiment of the present invention.

FIG. 12 is a spectrum diagram showing the light luminance in the cases where a cold cathode fluorescent lamp (CCFL) and a light-emitting diode (LED) are used as a backlight.

* Description of Reference Numerals Indicating Primary
Elements in the Drawings *

| | |
|---|---|
| 100: first display panel | 101: first thin film transistor |
| 102: second thin film transistor | 110: first substrate |
| 121: gate line | 124: gate electrode |
| 128: storage electrode line | 130: gate insulating layer |
| 140: semiconductor layer | 165: source electrode |
| 166: drain electrode | 170: passivation layer |
| 175: color filter | 179: capping layer |
| 181: first electrode | 182: second electrode |
| 191: protrusion | 200: second display panel |
| 210: second substrate | 300: liquid crystal layer |
| 400, 960: blue phase liquid crystal | 410, 420: polarizer |
| 950: color filter | 930, 980: UV-absorbing film |
| 910: transmittance at CCFL | |
| backlight wavelengths | |
| 900: transmittance at LED | |
| backlight wavelengths | |
| 990: external light | |

### DETAILED DESCRIPTION OF THE EMBODIMENTS

Hereinafter, exemplary embodiments of the present invention will be described in detail with reference to the accompanying drawings, so that those having ordinary skill in the art to which the present invention pertains will readily appreciate the present invention. The present invention may be implemented in various forms and is not limited to the exemplary embodiments described herein.

Moreover, in the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

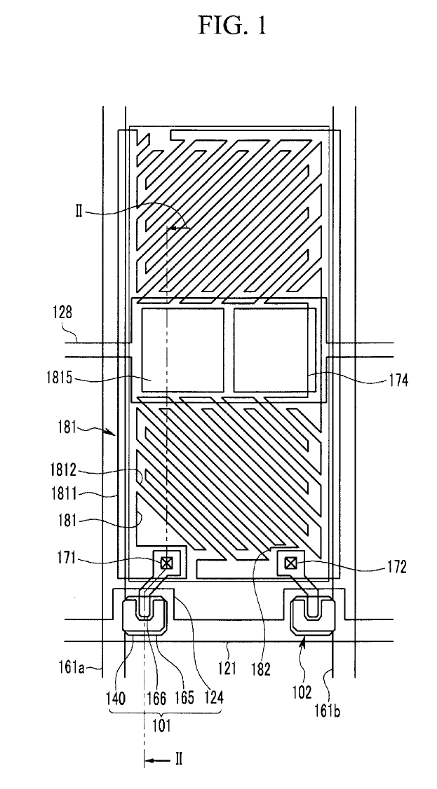

In FIG. 1, a display device employing an amorphous silicon (a-Si) thin film transistor (TFT) formed by five mask processes in accordance with an exemplary embodiment of the present invention is schematically shown.

In the exemplary embodiment of FIG. 1, two thin film transistors are used in each pixel. The pixel refers to a minimum unit displaying an image. However, the thin film transistor of the present invention may be implemented in various different forms and is not limited to the exemplary embodiments described herein.

To explicitly describe the exemplary embodiments of the present invention, description of the other elements not directly related to the exemplary embodiments of the present invention will be omitted, and the same reference numerals designate the same or similar constituent elements throughout the specification.

Moreover, in various exemplary embodiments, the same constituent elements are denoted by the same reference numerals as those in the first exemplary embodiment, and in other exemplary embodiments, only the constituent elements that are different from those in the first exemplary embodiment will be described.

### Exemplary Embodiment 1

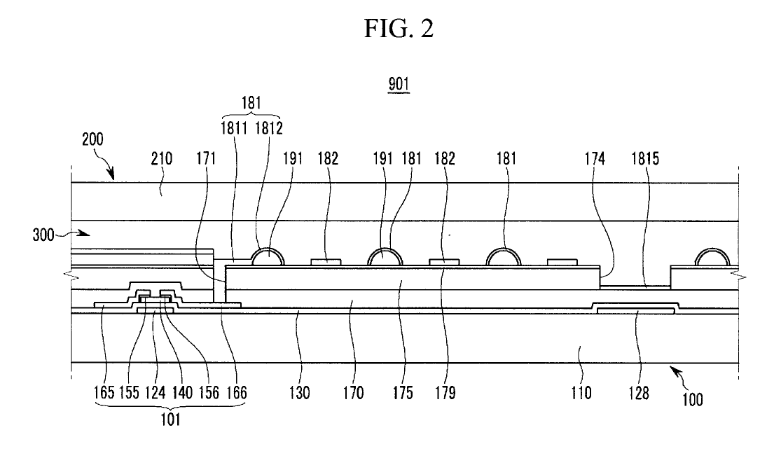

The first exemplary embodiment of the present invention will be described with reference to FIGS. 1 to 13. FIG. 1 is a layout view of a display device 901 in accordance with the first exemplary embodiment of the present invention, and FIG. 2 is a cross-sectional view taken along line II-II of FIG. 1.

As shown in FIGS. 1 and 2, the display device 901 includes a first display panel 100, a second display panel 200, and a liquid crystal layer 300. Here, the first display panel 100 includes a first substrate 110, a first electrode 181 formed on the first substrate 110, and a second electrode 182 formed on the first substrate 110 and spaced from the first electrode 181. At least one of the first electrode 181 and the second electrode 182 may be formed on a protrusion 191.

The other elements constituting a blue phase liquid crystal display in accordance with the first exemplary embodiment of the present invention will be described in detail below.

First, the liquid crystal layer 300 includes a network structure in which a low molecular weight liquid crystal is cross-linked with a non-liquid crystal monomer. The non-liquid crystal monomer may include, but is not limited to, an acrylate monomer that is polymerized by heat or ultraviolet light. Moreover, the non-liquid crystal monomer may include monomers having a polymerizable group such as a vinyl group, an acryloyl group, a fumarate group, etc. Meanwhile, an initiator for initiating polymerization of a cross-linker and the monomer may be used, if necessary. The initiator may include acetophenone, benzophenone, etc. Moreover, a chiral dopant for inducing a chiral nematic phase may be added to the liquid crystal layer 300.

The low molecular weight liquid crystal may include a material that exhibits a blue phase between a cholesteric phase and an isotropic phase. The low molecular weight liquid crystal includes a molecular structure such as biphenyl, cyclo, hexyl, etc., and the low molecular weight liquid crystal itself may have chirality or include a material that exhibits the cholesteric phase by addition of a chiral dopant.

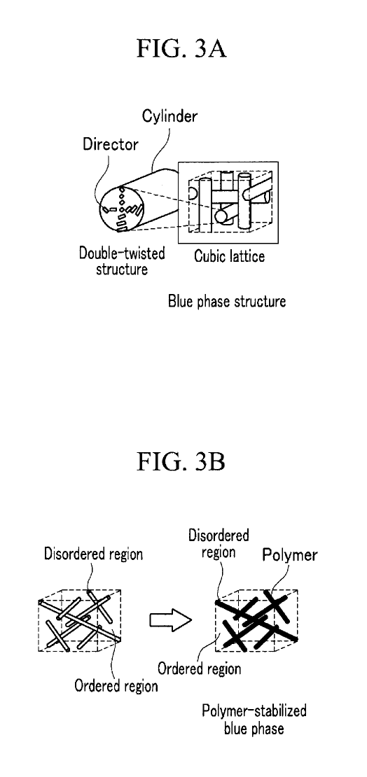

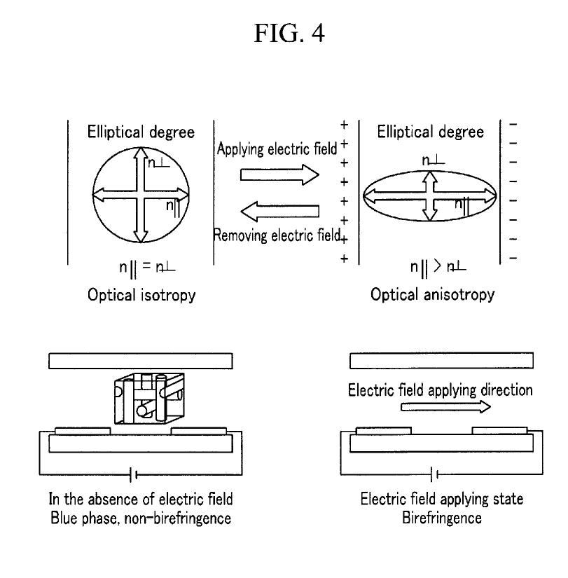

A blue phase liquid crystal used in the display device 901 in accordance with the exemplary embodiment of the present invention will be described below with reference to FIGS. 3 and 4.

As shown in FIG. 3A, the blue phase liquid crystal exhibits a blue phase when a chiral phase is induced in a positive liquid crystal and the temperature is lowered to several degrees K. (absolute temperature), and the blue phase liquid crystal takes a twist alignment in all azimuths of a molecular lateral direction and forms a cylinder having a double-twist structure as basic structure. Further, the cylinders crisscross each other to take an ultra structure having a cubic lattice as the unit lattice.

As shown in FIG. 3B, blue phase liquid crystal includes an ordered region having cubic lattice and a disordered region having a periodical disclination it is possible to obtain a stabilized blue phase in the room temperature region by mixing a photo-curable polymer with the liquid crystal.

Since the blue phase that is stabilized in a wider temperature range by the polymer has a high K constant {K constant (Δn=K·λ E2) by Kerr effect), it is possible to express gradation in the index of refraction by applying an electric field, while having optical isotropy in the absence of a voltage.

As shown in FIG. 4, the blue phase liquid crystal has optical isotropy in the absence of a voltage, it exhibits a blue phase, and it does not have birefringence. When an electric field is applied thereto, the blue phase liquid crystal has optical anisotropy and birefringence. In the embodiment depicted in FIG. 4, the electric field is applied to the blue phase liquid crystal in the horizontal direction, i.e., in a direction perpendicular to the propagation of light passing through the liquid crystal layer 300.

Moreover, the blue phase liquid crystal used in the present invention may have a chiral pitch of less than about 300 nm, and more particularly of about 200 nm. The reason is that it is preferable for the chiral pitch of the blue phase liquid crystal to not overlap the wavelength region of visible radiation. Since the wavelength region of visible radiation is about 350 nm to 650 nm, it is preferable that the blue phase liquid crystal has a chiral pitch of less than about 300 nm. Further, the external reflection of the liquid crystal is reduced at a chiral pitch of less than 200 nm, and thus the contrast ratio is high.

Moreover, the dielectric constant and refractive index of the blue phase liquid crystal are very high, and the blue phase liquid crystal has a nematic phase.

The first display panel 100 includes a plurality of gate lines 121, a plurality of data lines 161a and 161b, and a plurality of thin film transistors 101 and 102, all of which are formed on the first substrate 110. Moreover, the first display panel 100 includes a color filter 175.

Two thin film transistors 101 and 102 are disposed in each pixel. That is, each pixel has a first thin film transistor 101 and a second thin film transistor 102. The first thin film transistor 101 is electrically connected to the first electrode 181, and the second thin film transistor 102 is electrically connected to the second electrode 182.

The first thin film transistor 101 and the second thin film transistor 102 are connected to the same gate line 121. Moreover, the first thin film transistor 101 and the second thin film transistor 102 are connected to different data lines 161a and 161b. Different voltages are applied to the first electrode 181 and the second electrode 182, and a horizontal electric field is generated between the first electrode 181 and the second electrode 182. The blue phase liquid crystal is driven by the horizontal electric field generated between the first electrode 181 and the second electrode 182.

Each of the first electrode 181 and the second electrode 182 has a slit pattern, and they may be engaged with each other in a comb-tooth shape as shown in FIG. 1. Here, since the protrusion 191 is disposed below the first electrode 181, the horizontal electric field can be effectively generated between the first electrode 181 and the second electrode 182. This is because, although the second electrode 182 is formed to be planar, the first electrode 181 is formed to have a height due to the protrusion 191 disposed below the first electrode 181. In other words, forming at least one of the first or second electrodes on a protrusion 191, ensures that the electric field generated between said first and second electrodes will have a large horizontal component (“horizontal” being parallel to the plane of the liquid crystal display device), therefore said electric field being more effective at inducing the anisotropic phase in the liquid crystal layer.

Each of the first electrode 181 and the second electrode 182 has a width in the range of 1 μm to 10 μm, and the edge of the first electrode 181 and the edge of the second electrode 182 are spaced apart by a distance in the range of 3 μm to 6 μm. It is preferable for the spacing distance between the first electrode 181 and the second electrode 182 to be smaller. However, the spacing distance between the first electrode 181 and the second electrode 182 may be determined to be within 3 μm to 6 μm in consideration of a process-error margin, in an actual manufacturing process.

Since it is advantageous to reduce the driving voltage in the display device 901 using the blue phase liquid crystal in various aspects, the widths of the first electrode 181 and the second electrode 182 may be smaller than or equal to the distance between the first electrode 181 and the second electrode 182. Therefore, the driving voltage applied to the first electrode 181 and the second electrode 182 is reduced. Moreover, the average distance between the first substrate 110 and a second substrate 210 may be more than 4.5 μm. Here, the average distance between the first substrate 110 and the second substrate 210 represents a space that is substantially filled with the liquid crystal layer 300 between the first substrate 110 and the second substrate 210. That is, the first substrate 110 and the second substrate 210 may have a non-uniform distance therebetween in the range of 4 μm to 12 μm, and the overall average distance between the first substrate 110 and the second substrate 210 may be more than 4.5 μm.

Next, the structure of the display device 901 will be described in detail with reference to FIG. 2, based on the stacking order and the shape of the protrusion 191.

The structure of the display device 901 is shown in FIG. 2, based on the first thin film transistor 101. Although the thin film transistor will be represented as the first thin film transistor 101 hereafter, the second thin film transistor 102 has substantially the same structure as the first thin film transistor 101.

First, the structure of the first display panel 100 will be described.

The first substrate 110 is formed of a material such as glass, quartz, ceramic, or plastic to be transparent.

Gate wires 121, 124, and 128 including the plurality of gate lines 121 (shown in FIG. 1), a plurality of gate electrodes 124 branched from the gate lines 121, and a plurality of storage electrode lines 128 are formed on the first substrate 110.

The gate wires 121, 124, and 128 are formed of a metal selected from the group consisting of aluminum (Al), silver (Ag), chromium (Cr), titanium (Ti), tantalum (Ta), molybdenum (Mo), copper (Cu), and alloys thereof. While the gate wires 121, 124, and 128 are shown in a single layer in FIG. 2, the gate wires 121, 124, and 128 may have a multi-layered structure including a metal layer formed of a metal selected from the group consisting of chromium (Cr), molybdenum (Mo), titanium (Ti), tantalum (Ta), and alloys thereof, which have excellent physiochemical characteristics, and a metal layer formed of aluminum (Al) or an alloy thereof, which have low specific resistivity. Further, the gate wires 121, 124, and 128 may be formed of various metals or conductors and may be formed into a multi-layer film that is capable of being patterned under the same etching conditions.

A gate insulating layer 130 formed of silicon nitride (SiNx) or the like is formed on the gate wires 121, 124, and 128.

Data wires 161a, 161b, 165, and 166 including the plurality of data lines 161a and 161b (shown in FIG. 1) intersecting the gate lines 121, a plurality of source electrodes 165 branched from the data lines 161 and 161b, and a plurality of drain electrodes 166 spaced from the source electrodes 165 are formed on the gate insulating layer 130.

Like the gate wires 121, 124, and 128, the data wires 161a, 161b, 165, and 166 may be formed of a conductive material selected from the group consisting of chromium (Cr), molybdenum (Mo), aluminum (Al), copper (Cu), and alloys thereof, and may be formed in a single layer or a multi-layer.

A semiconductor layer 140 is formed in a region including the top of the gate insulating layer 130 on the gate electrode 124 and the top and bottom of the source electrode 165 and the drain electrode 166. In detail, at least a portion of the semiconductor layer 140 overlaps the gate electrode 124, the source electrode 165, and the drain electrode 166. Here, the gate electrode 124, the source electrode 165, and the drain electrode 166 correspond to the three electrodes of the thin film transistor 101. The semiconductor layer 140 between the source electrode 165 and the drain electrode 166 corresponds to a channel region of the thin film transistor 101.

Moreover, ohmic contacts 155 and 156 are formed between the semiconductor layer 140 and the source electrode 165 and between the semiconductor layer 140 and the drain electrode 166 to reduce the contact resistance therebetween. The ohmic contacts 155 and 156 are formed of amorphous silicon doped with silicide or n-type impurities.

A passivation layer 170 including a low dielectric constant insulating material such as a-Si:C:O or a-Si:O:F, an inorganic insulating material such as silicon nitride or silicon oxide, or an organic insulating material is deposited on the data wires 161a, 161b, 165, and 166 by plasma enhanced chemical vapor deposition (PECVD).

A color filter 175 having three primary colors, for example red R, green G, and blue B, is sequentially disposed on the passivation layer 170. In this case, the colors of the color filter 175 are not limited to the three primary colors, and may include at least one color in various ways. For example, the color filter 175 includes at least one color different from three primary colors.

The color filter 175 serves to impart a color to the light passing through the display device 901.

While the color filter 175 is stated to be formed on the passivation layer 170, the present invention is not limited thereto. Thus, the color filter 175 may be formed between the passivation layer 170 and the data wires 161a, 161b, 165, and 166. Moreover, the color filter 175 may be formed on the second display panel 200 instead of the first display panel 100.

A capping layer 179 is formed on the color filter 175. The capping layer 179 protects organic layers including the color filter 175. The capping layer 179 is not necessarily required, and may be omitted if necessary. The capping layer 179 may be formed of various materials such as inorganic layers including the same material as the passivation layer 170.

The protrusion 191 is formed on the capping layer. The protrusion 191 may be formed of a photosensitive organic material by an exposure/development process. However, the present invention is not limited thereto, and the protrusion 191 may be formed of various materials.

The protrusion 191 has a semicircular or semi-elliptical cross-section. Moreover, the protrusion 191 may have a width in the range of 1 μm to 10 μm. Furthermore, the protrusion 191 may have a height of more than ⅙ of the average distance between the first substrate 110 and the second substrate 210.

The first electrode 181 and the second electrode 182 are formed on the protrusion 191 and the capping layer 179. In the embodiment depicted in FIG. 2, the first electrode 181 is formed on the protrusion 191, and the second electrode 182 is formed on the capping layer 179. The first electrode 181 is connected to the first thin film transistor 101, and the second electrode 182 is connected to the second thin film transistor 102 (shown in FIG. 1). The first electrode 181 and the second electrode 182 include a transparent conductor such as indium tin oxide (ITO) or indium zinc oxide (IZO). In detail, the first electrode 181 includes an electrode portion 1812 formed on the protrusion 191 and a connecting portion 1811 connecting the electrode portion 1812 and the thin film transistor 101. Moreover, a portion 1815 of either one of the first electrode 181 and the second electrode 182 overlaps a first storage electrode line 128 to form a storage capacitor.

The passivation layer 170 and the color filter 175 have a plurality of contact holes 171 and 172 exposing a portion of each drain electrode 166. The first electrode 181 and the second electrode 182 are electrically connected to the drain electrodes 166 of the first thin film transistor 101 and the second thin film transistor 102 through the contact holes 171 and 172, respectively. The color filter 175 has an opening 174 formed on the first storage electrode line 128.

The alignment state of the blue phase liquid crystal of the liquid crystal layer 300 varies in accordance with a horizontal electric field generated between the first electrode 181 and the second electrode 182, and thus the light transmittance is adjusted.

Next, the structure of the second display panel 200 will be described.

The second display panel 200 includes the second substrate 210. Like the first substrate 110, the second substrate 210 is formed of a material such as glass, quartz, ceramic, or plastic to be transparent.

However, the second substrate 210 may be formed of plastic to reduce weight and thickness. The plastic may include, but is not limited to, polycarbonate, polyimide, polyethersulfone (PES), polyarylate (PAR), polyethylene naphthalate (PEN), polyethylene terephthalate (PET), etc.

Moreover, the structures of the first display panel 100 and the second display panel 200 are not limited to the above-described structures. Thus, the present invention may be applied to display devices having various known structures other than the structure of the display device 901 shown in FIGS. 1 and 2.

The liquid crystal layer 300 employed in the display device 901 in accordance with the exemplary embodiment of the present invention is a cross-linked blue phase liquid crystal. That is, the liquid crystal layer 300 is a blue phase liquid crystal in which a monomer is included and the included monomer is cured and polymerized. The blue phase is one of the liquid crystal phases exhibited in the temperature range of several degrees K. between a cholesteric phase and an isotropic phase.

The blue phase liquid crystal does not need to have an alignment layer formed on the first substrate 110 and the second substrate 210. When a voltage is not applied to the blue phase liquid crystal, it is in an optically isotropic state, and when the applied voltage is increased, the number of directors aligned in the electric field direction is increased such that the blue phase liquid crystal has refractive anisotropy, thus changing the polarization state. In the case where the blue phase liquid crystal is used, the display device 901 is in a normally black mode. That is, the display device 901 displays black when no voltage is applied.

Meanwhile, since the blue phase liquid crystal has a narrow temperature range, a non-liquid crystal monomer is added to a low molecular weight liquid crystal that is capable of exhibiting a blue phase, and ultraviolet rays are applied to the monomer in order to be polymerized. Upon polymerization, a cross-linked blue phase liquid crystal having a stabilized crystal structure results. The cross-linked blue phase liquid crystal has a structure in which a polymer network structure is formed with the low molecular weight liquid crystal.

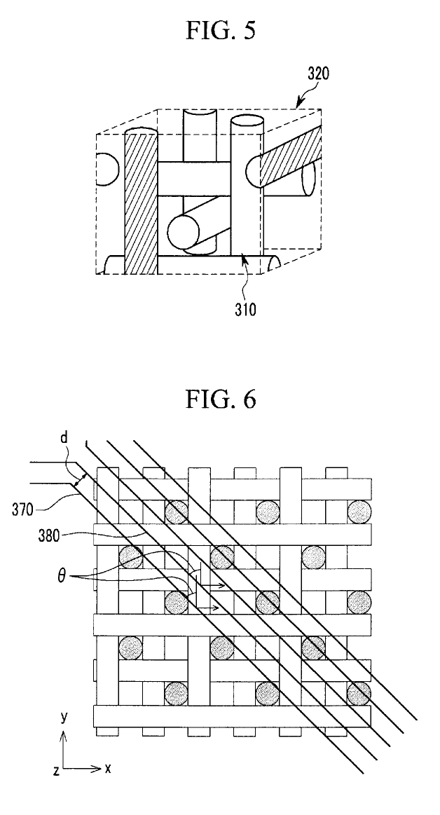

Moreover, as shown in FIGS. 5 and 6, the inside of the cross-linked blue phase liquid crystal has cubic lattice structures 310, 320, in which the blue phase has a regular array, which causes the reflection by crystal lattice surfaces 370, and 380, which is one of the reflections of plane waves such as X-rays or particulate rays, incident on crystals, known as “Bragg reflection”. The Bragg reflection may be compared with the crystal lattice in the blue phase liquid crystal by the following Formulas 1 to 3.

λ=(2np)/(√h²+k²+l²) ——— wavelength [Formula 1]

λ<W nm ——— W:maximum UV absorption wavelength [Formula 2]

p<{W*(√h²+k²+l²)}/(2*n) ——— pitch of blue phase LC<n: average refractive index=1.55825, and lattice index: (1, 1, 0)> [Formula 3]

If the distance between adjacent lattice surfaces is a lattice surface distance and its value is d, if the angle formed between X-rays and the lattice surface is θ, if the wavelength of X-rays is λ, and if n is any integer, the conditions under which X-ray waves reflected on the respective lattice surfaces are strongly coupled to cause Bragg reflection are expressed as an equality such as 2 d sin θ=nλ.

Determination of the atomic structure of crystals is made based on the measurement of the Bragg reflection. The surface distance value d has a value determined according to a plane index (k, k, l) of the lattice surface.

That is, the circular polarization selected by the light selectivity induced by chirality for external light is reflected, and the unselected circular polarization is transmitted as it is. This is the reason why a light leakage is observed on the front side of the liquid crystal cell even though the polarization axes of the polarizers attached to upper and lower substrates are perpendicular to each other (cross-polarization). As shown in FIG. 10, the selective reflection phenomenon is observed as a reduction in transmission of backlight 820, and is also observed as external light 840 reflected on the front side.

FIG. 10 shows the reflection phenomenon in the actual liquid crystal cell measured by an ultraviolet-visible spectrometer (UV/VIS spectrometer). As shown in FIG. 10, the upward slope of a transmission curve 810 is stopped in the vicinity of the wavelength of about 410 nm, and the curve 810 goes down for a short distance and rises again, which corresponds to the selective reflection 820 of the backlight. The reflection curve 830 of the external light shows a peak in the vicinity of the wavelength of about 410 nm, which corresponds to the selective reflection 840 of the external light.

At this time, the factor to be considered in the exemplary embodiment of the present invention is that the selective reflection is made with respect to the light in a predetermined wavelength range.

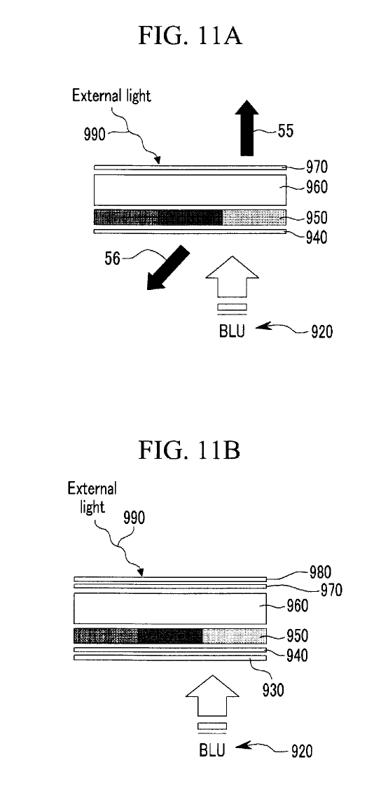

As mentioned above, the selective reflection phenomenon causes a broadening phenomenon by Δn and Δp. Therefore, in order to completely remove the selective reflection, it is necessary to consider a reflection range. Since the reflection range is about 20 to 25 nm, as can be seen by the selective reflection feature 840 in FIG. 11, it is possible to remove the selective reflection phenomenon by providing a margin corresponding to the reflection range when an element for absorbing ultraviolet radiation is provided.

That is, in FIG. 10, when the wavelength of about 410 nm at which the maximum reflection is exhibited is cut together with the wavelength range over 20 to 25 nm including the adjacent wavelength range, by using an absorption filter, the effect of the present invention is maximized.

The blue phase liquid crystal cell is problematic in that the transmittance is reduced and it has a bluish cast in a black state due to the reflection occurring on the surface of the blue phase liquid crystal cell. In order to solve the latter problem, the amount of chiral dopant added to the blue phase liquid crystal cell is increased, so the pitch of the liquid crystal in the cubic lattice structure of the blue phase liquid crystal is reduced. Then, since the pitch (p) of the liquid crystal is proportional to the reflection wavelength (λ), as can be seen from Formulas 1 to 3, the reflection wavelength (λ) is also reduced. In more detail, when the pitch of the liquid crystal is reduced, the liquid crystal causes the selective reflection to occur at a shorter wavelength than the wavelength of 390 nm to about 410 nm at which the selective reflection normally occurs (cf. FIG. 10). Accordingly, when it is considered that the polarizer basically absorbs the light having a wavelength of less than 380 nm, it is possible to improve the deterioration of contrast ratio due to the selective reflection of the blue phase liquid crystal.

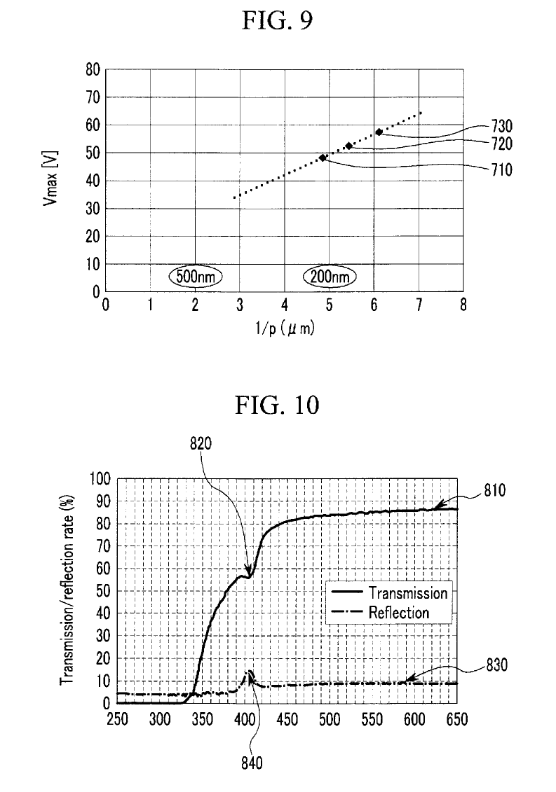

However, it can be seen from FIG. 9 that it is not easy to reduce the pitch of the liquid crystal since the driving voltage of the liquid crystal cell increases in inverse proportion to the reduction of the pitch of the liquid crystal (p). In detail, in the case where the pitch (p) of the liquid crystal is 200 nm (1/p=5/μm) in FIG. 9, the driving voltage corresponds to 50 V (710) and, in the case where the pitch is 166 nm (1/p=6/μm), the driving voltage corresponds to 57 V (730). However, it is inconvenient to apply a high driving voltage near 60 V to the liquid crystal cell since the drive IC should be redeveloped.

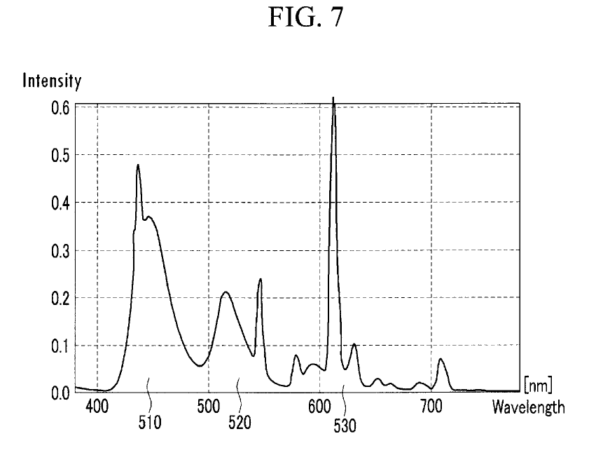

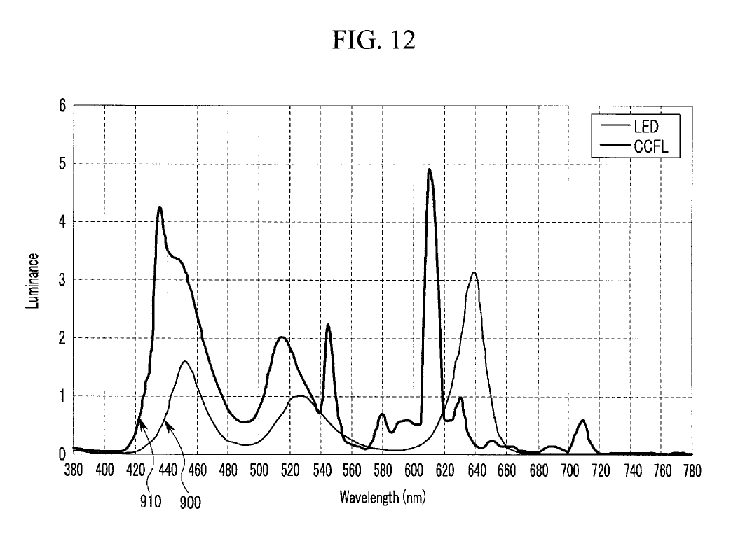

Thus, according to the first exemplary embodiment of the present invention, as shown in FIG. 12B, when light from the backlight or external light is incident on the blue phase liquid crystal, and said light has a component with a wavelength corresponding to the Bragg reflection wavelength of the blue phase liquid crystal, if the corresponding wavelength is removed using a UV-absorbing (cutting) film, it is possible to completely remove the reflection phenomenon occurring on both sides of the panel. Moreover, even in the case where the UV-absorbing film is provided only on the upper side of the liquid crystal cell, it is possible to obtain the effect of removing the selective reflection phenomenon. As shown in FIG. 7, the reason is that the intensity of light emitted by the backlight is significantly reduced at a wavelength of less than about 420 nm, and thus it is possible to obtain a sufficient effect even if the UV-absorbing film is disposed on the side of the liquid crystal cell exposed to the external light.

However, although the intensity of light emitted by the backlight in the wavelength region of less than about 420 nm is weak and it may not be seen when compared to the intensity of light in the visible region, the weak light may play a significant role in increasing the luminance in a black state, and thus it is concluded that the UV-absorbing films attached to both upper and lower sides of the liquid crystal cell in the first exemplary embodiment can completely remove the selective reflection phenomenon, thereby obtaining a better effect.

Moreover, in the exemplary embodiment of the present invention, an absorber for absorbing ultraviolet rays in the wavelength range of less than about 410 nm is formed on the polarizers attached to the upper and lower substrates of the liquid crystal cell to remove the wavelength range as the selective reflection wavelength in FIG. 10, from the light incident to the liquid crystal cell, without changing the pitch of the liquid crystal. The absorber is formed on at least one of a triacetyl cellulose (TAC) layer, a polyvinyl alcohol (PVA) layer, an adhesive layer, and a protective layer of the polarizer.

With the use of the absorber, it is possible to remove the reflection of the liquid crystal cell, improve the contrast ratio, and remove the bluish cast.

It is suitable for the liquid crystal display in which the polarizers having the absorber absorbing light having a wavelength of less than about 410 nm are applied to the upper and lower substrates to be applied to a mode in which the Bragg reflection occurs since the pitch of the liquid crystal such as the blue phase liquid crystal has a crystal structure.

It may be considered that the transmittance of the liquid crystal cell is reduced by the polarizers having the absorber absorbing light having a wavelength of less than about 410 nm applied, the liquid crystal displays, which are mainly used at present, employ a CCFL or LED backlight, and the wavelength of light emitted from the backlight is more than about 410 nm as shown in FIG. 7. That is, since blue, green, and red components 510, 520, and 530 are all in the wavelength range of more than about 410 nm, the luminance is hardly reduced even if the polarizers having the wavelength absorber in accordance with the exemplary embodiment of the present invention are adopted in the blue phase liquid crystal display.

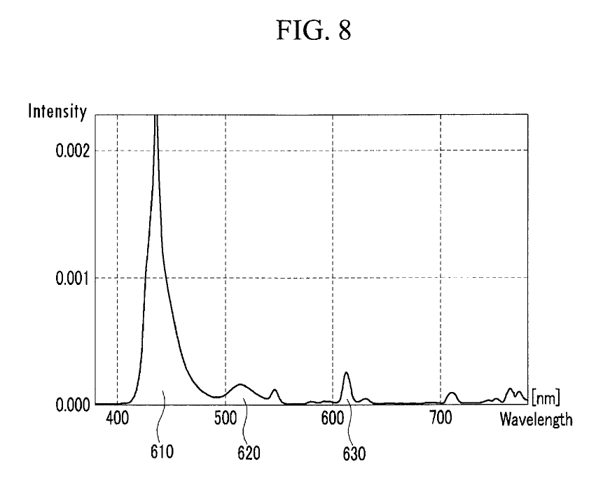

FIG. 8 shows the black state measured after turning off the driving voltage of the blue phase liquid crystal display. Here, it can be seen that the luminance (light intensity) is highest at the blue region 610, and the luminance at the green region 620 and the luminance at the red region 630 are relatively low. Light leaks in the black state of the blue region 610, which is a major factor that makes the screen of the blue phase liquid crystal display look bluish.

In the structure of FIG. 11A, the light emitted from the external light or the backlight makes the screen of the blue phase liquid crystal display look bluish due to the Bragg reflection 55 and 56 by the lattice structure of the liquid crystal of the blue phase liquid crystal display.

However, as shown in FIG. 11B, when UV-absorbing films 930 and 980 are disposed on both sides of upper and lower substrates 940 and 970 of a liquid crystal cell 960 of the blue phase liquid crystal display, they remove the reflection of light emitted from an external light 990 and a backlight 920 to reduce the luminance, and thus it is possible to improve the contrast ratio of the liquid crystal display and prevent the screen from looking bluish.

The UV-absorbing films 930 and 980 may be formed integrally with or separately from the polarizers.

Here, while the UV-absorbing film formed integrally with the polarizer is not shown, it is possible to form the UV-absorbing film on at least one surface of the TAC layer, the PVA layer, and the adhesive layer, which constitute the polarizer, and particularly, it is possible to form an absorber absorbing light having a wavelength of less than about 410 nm as an independent layer of the polarizer. However, as described above, since the selective reflection has a certain range, it is possible to employ an absorber that is capable of removing ultraviolet rays in a predetermined range of more than about 410 nm by considering the above fact.

Reviewing a CCFL spectrum 910 and an LED spectrum 900 shown in FIG. 12, it can be seen that the main peak in the blue region is shown at about 440 to 460 nm, and the wavelength range of the blue region begins at about 420 nm. Particularly, it can be seen that the LED spectrum 900 has a narrower band range.

Here, the light in the wavelength range of less than about 420 nm may be absorbed to more effectively remove the bluish cast of the blue phase liquid crystal display, when considering the wavelength distribution of the backlight shown in FIG. 7 and FIG. 12.

FIG. 12 shows the CCFL and white LED backlight luminance spectra. Here, it can be seen from the luminance curve 910 of the CCFL backlight and the luminance curve 900 of the LED backlight that the luminance is sharply increased at wavelengths longer than about 420 nm and is very low at wavelengths shorter than about 420 nm.

Therefore, it is possible to set the UV absorbing-wavelength of the UV-absorbing filter of the polarizer to about 420 nm.

In other words, in the case where the UV-absorbing wavelength of the UV-absorbing filter included in the polarizer or provided as an independent film is set to less than about 420 nm, it is possible to remove the bluish phenomenon due to the selective reflection by setting the pitch of the blue phase liquid crystal such that the reflection peak does not exceed about 420 nm.

In another embodiment of the present invention, a polarizer that absorbs light having a wavelength of 380 nm may be employed by designing the liquid crystal to have a selective reflection wavelength of about 360 nm by a method of controlling the amount of chiral dopant included in the blue phase liquid crystal. However, when the UV-absorbing wavelength range is increased to about 420 nm in accordance with the exemplary embodiment of the present invention, it is possible to reduce the driving voltage more than about 6 V.

When the UV-absorbing film formed on the polarizer prevents light having a wavelength of below about 420 nm emitted from the backlight or external light from being incident to the surface of the liquid crystal cell in advance, it is possible to prevent the contrast deterioration of the blue phase liquid crystal display and prevent the bluish cast.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A display device comprising:
a first substrate;
a second substrate arranged opposite to the first substrate;
a liquid crystal layer disposed between the first substrate and the second substrate;
a first electrode and a second electrode formed on the second substrate;
a first polarizer disposed on an outer surface of the first substrate; and
a first UV-absorbing film formed on the outer surface of the first substrate,
wherein the liquid crystal layer undergoes a phase transition from an isotropic phase in the absence of a voltage to an anisotropic phase when an electric field is applied to the liquid crystal layer.

2. The display device of claim 1, wherein said first substrate and said second substrate are formed of a transparent material selected from the group consisting of glass, quartz, ceramic, and plastic.

3. The display device of claim 1, wherein said second substrate is formed of a plastic material including at least one of polycarbonate, polyimide, polyethersulfone, polyarylate, polyethylene naphthalate, and polyethylene terephthalate.

4. The display device of claim 1, wherein
the liquid crystal further comprises a polymer formed by polymerizing a monomer.

5. The display device of claim 1, wherein a low molecular weight liquid crystal is cross-linked with a non-liquid crystal monomer.

6. The display device of claim 5, wherein said non-liquid crystal monomer includes monomers having a polymerizable group including at least one of a vinyl group, an acryloyl group, and a fumarate group.

7. The display device of claim 5, wherein said liquid crystal layer is formed using an initiator for initiating polymerization of said low molecular weight liquid crystal and said non-liquid crystal monomer.

8. The display device of claim 7, wherein said initiator is selected from a group that includes at least one of acetophenone, and benzophenone.

9. The display device of claim 5, wherein said low molecular weight liquid crystal includes a material that exhibits a blue phase between a cholesteric phase and an isotropic phase.

10. The display device of claim 9, wherein said low molecular weight liquid crystal is mixed with a photo-curable polymer in order to obtain a stabilized blue phase at room temperature.

11. The display device of claim 5, wherein said low molecular weight liquid crystal includes a molecular structure such as biphenyl, cyclo, and hexyl.

12. The display device of claim 1, wherein a chiral dopant for inducing a chiral nematic phase is added to said liquid crystal layer.

13. The display device of claim 5, wherein said non-liquid crystal monomer comprises an acrylate monomer that is polymerized by heat or ultraviolet light.

14. The display device of claim 1, wherein
said first UV-absorbing film is formed integrally with the first polarizer.

15. The display device of claim 1, wherein
said first UV-absorbing film absorbs light having a wavelength of less than about 410 nm.

16. The display device of claim 1, wherein
said first UV-absorbing film absorbs light having a wavelength of less than about 420 nm.

17. The display device of claim 16, wherein
the first UV-absorbing film absorbs light having a wavelength of about 380 to about 420 nm.

18. The display device of claim 1, further comprising:
a second polarizer formed on an outer surface of the second substrate; and
a second UV-absorbing film formed on the outer surface of the second substrate.

19. The display device of claim 18, wherein
the first UV-absorbing film and the second UV-absorbing film are formed integrally with the first polarizer and the second polarizer, respectively.

20. The display device of claim 19, wherein
the first UV-absorbing film and the second UV-absorbing film cut light having a wavelength of less than about 420 nm.

21. The display device of claim 20, wherein
the first UV-absorbing film and the second UV-absorbing film absorb light having a wavelength of about 380 to about 420 nm.

22. The display device of claim 18, wherein
the first UV-absorbing film and the second UV-absorbing film are formed on at least one of a triacetyl cellulose layer, a polyvinyl alcohol layer, and an adhesive layer, which constitute the first polarizer and the second polarizer.

23. The display device of claim 18, further comprising
a cold cathode fluorescent lamp backlight disposed on the outer surface of the second substrate.

24. The display device of claim 18, further comprising
a light-emitting diode backlight disposed on the outer surface of the second substrate.

25. The display device of claim 18, wherein
the first UV-absorbing film and the second UV-absorbing film absorb light having a wavelength of less than about 420 nm.

26. The display device of claim 18, wherein
the first UV-absorbing film and the second UV-absorbing film absorb light having a wavelength of less than about 410 nm.

27. The display device of claim 25, wherein
the first UV-absorbing film and the second UV-absorbing film absorb light having a wavelength of about 380 to about 420 nm.

28. The display device of claim 18, wherein
the first UV-absorbing film is disposed on the outer surface of the first polarizer, and the second UV-absorbing film is disposed on the outer surface of the second polarizer.

29. The display device of claim 1, further comprising:
a first thin film transistor formed on the first substrate and connected to the first electrode; and
a second thin film transistor formed on the first substrate and connected to the second electrode; and wherein
said first and second thin film transistors each comprising a gate electrode, a source electrode and a drain electrode.

30. The display device of claim 29, further comprising
a plurality of gate lines formed on the first substrate,
wherein the first thin film transistor and the second thin film transistor are connected to the same gate line.

31. The display device of claim 30, further comprising
a plurality of storage electrode lines formed on the first substrate

32. The display device of claim 31, wherein said plurality of gate lines and said plurality of storage electrode lines is formed of a metal selected from the group consisting of aluminum, silver, chromium, titanium, tantalum, molybdenum, copper, and alloys thereof.

33. The display device of claim 31, wherein said plurality of gate lines and said plurality of storage electrode lines comprise gate wires; and
said gate wires having a multi-layered structure including a metal layer formed of a metal selected from the group consisting of chromium, molybdenum, titanium, tantalum and alloys thereof; and
said gate wires further comprising a metal layer formed of aluminum or an alloy thereof.

34. The display device of claim 31, wherein a gate insulating layer is formed on said plurality of gate lines and said plurality of storage electrode lines.

35. The display device of claim 29, further comprising
a plurality of data lines formed on the first substrate,
wherein the first thin film transistor and the second thin film transistor are connected to different data lines.

36. The display device of claim 35, wherein said plurality of data lines is formed of a conductive material selected from the group consisting of chromium, molybdenum, aluminum, copper, and alloys thereof.

37. The display device of claim 35, wherein said plurality of data lines is formed in a multilayer.

38. The display device of claim 34 further comprising:
a semiconductor layer formed directly on top of said gate insulating layer; and
at least a portion of said semiconductor layer overlapping the three electrodes of at least one of the first and second thin film transistors; and
said semiconductor layer forming a channel of the said at least one of the first and second thin film transistors, between the source electrode and the drain electrode of the said at least one of the first and second thin film transistors.

39. The display device of claim 38, wherein an ohmic contact is formed between said semiconductor layer and said source and drain electrodes of said at least one of the first and second thin film transistors.

40. The display device of claim 35, wherein a passivation layer is deposited directly on said data lines; said passivation layer having a plurality of contact holes exposing a portion of each drain electrode of the first and second thin film transistors.

41. The display device of claim 40, wherein said passivation layer is formed of a material including at least one of a low dielectric constant insulating material, a-Si:C:O, a-Si:O:F, an inorganic insulating material, silicon nitride, silicon oxide, and an organic insulating material.

42. The display device of claim 35, further comprising
a color filter layer formed on the thin film transistor.

43. The display device of claim 42, wherein the color filter layer comprises three primary colors sequentially disposed.

44. The display device of claim 42, wherein the color filter layer comprises at least one color different from three primary color.

45. The display device of claim 42, wherein said color filter layer has an opening formed on at least one of the said storage electrode lines.

46. The display device of claim 42, wherein said color filter layer has a plurality of contact holes exposing a portion of each drain electrode of the first and second thin film transistors.

47. The display device of claim 40, further comprising a portion of the first electrode or a portion of the second electrode overlapping at least one of the said storage electrode lines to form a storage capacitor.

48. The display device of claim 42, further comprising
an inorganic capping layer formed on the color filter layer.

49. The display device of claim 48, further comprising a protrusion formed on said inorganic capping layer.

50. The display device of claim 49, wherein said protrusion is formed from a photosensitive organic material by an exposure and development process.

51. The display device of claim 49, wherein said protrusion is provided with a semi-circular or semi-elliptical cross-section.

52. The display device of claim 49, wherein said protrusion has a width in the range of 1 micrometer to 10 micrometers; and further wherein said protrusion has a height of more than ⅙ of the average distance between the first substrate and the second substrate.

53. The display device of claim 49, further comprising a first electrode and a second electrode formed on said inorganic capping layer; and
wherein at least one of the said first and said second electrodes is formed directly on said protrusion.

54. The display device of claim 53, wherein the at least one of the said first and second electrodes includes an electrode portion formed on said protrusion and a connecting portion connecting said electrode portion and the at least one of the said first and second thin film transistors.

55. The display device of claim 53, wherein each of the said first and said second electrodes has a width in the range of 1 micrometer to 10 micrometer.

56. The display device of claim 53, wherein the said first and second electrodes are spaced apart by a distance in the range of 3 micrometers to 6 micrometers.

57. The display device of claim 53, wherein the width of said first and second electrodes may be smaller than or equal to the distance between said first electrode and said second electrode.

58. The display device of claim 29, further comprising:
a second polarizer formed on the outer surface of the second substrate; and
a second UV-absorbing film formed on the outer surface of the second substrate.
